(19) United States
(12) Patent Application Publication
(10) Pub. No.: US 2026/0058753 A1
(43) Pub. Date: Feb. 26, 2026

(54) SPATIALLY COUPLED MULTIPLE-INPUT MULTIPLE-OUTPUT WITH SHAPING

(71) Applicant: QUALCOMM Incorporated, San Diego, CA (US)

(72) Inventors: Kirill IVANOV, La Jolla, CA (US); Wei YANG, San Diego, CA (US); Pinar SEN, San Diego, CA (US); Jing JIANG, San Diego, CA (US); Hari SANKAR, San Diego, CA (US); Li ZHANG, San Diego, CA (US)

(21) Appl. No.: 18/810,118

(22) Filed: Aug. 20, 2024

(51) Int. Cl. H04L 1/00; H04B 7/0413

(52) U.S. Cl. CPC H04L 1/0042; H04B 7/0413; H04L 1/0058

(57) ABSTRACT

Certain aspects of the present disclosure provide techniques for wireless communications at a wireless node, generally including applying a probabilistic shaping function to at least a subset of information bits to generate shaped bits, encoding the shaped bits and unshaped bits to generate code blocks, mapping different parts of the code blocks to different multiple-input multiple-output (MIMO) layers, and outputting the different parts of the code blocks, for transmission, via the different MIMO layers according to the mapping.

### FIELD OF THE DISCLOSURE

Aspects of the present disclosure relate to wireless communications, and more particularly, to techniques for multiple-input multiple-output (MIMO) communications with probabilistic shaping.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a wireless node. The method includes applying a probabilistic shaping function to at least a subset of information bits to generate shaped bits; encoding the shaped bits and unshaped bits to generate code blocks; mapping different parts of the code blocks to different multiple-input multiple-output (MIMO) layers; and outputting the different parts of the code blocks, for transmission, via the different MIMO layers according to the mapping.

Another aspect provides a method for wireless communications at a wireless node. The method includes obtaining different parts of code blocks via different multiple-input multiple-output (MIMO) layers; and decoding the different parts of the code blocks to obtain information bits, wherein the decoding comprises applying a probabilistic de-shaping function when decoding at least some of the different parts of the code blocks.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts example transmit processing for MIMO communications with shaping, in accordance with certain aspects of the present disclosure.

FIG. 6A depicts a dual-code word (CW) multiple-input multiple-output (MIMO) structure.

FIG. 6B depicts a single-CW MIMO structure.

FIGS. 7A and 7B illustrate a structure that allows for successive cancellation (SIC), in accordance with certain aspects of the present disclosure.

FIG. 8 depicts a call flow diagram for MIMO communications with shaping, in accordance with certain aspects of the present disclosure.

FIG. 9 depicts a first example structure for MIMO communications with shaping, in accordance with certain aspects of the present disclosure.

FIG. 10 depicts example processing for MIMO communications with shaping, in accordance with certain aspects of the present disclosure.

FIG. 11 depicts a second example structure for MIMO communications with shaping, in accordance with certain aspects of the present disclosure.

FIG. 12 depicts example processing for MIMO communications with shaping, in accordance with certain aspects of the present disclosure.

FIG. 13 depicts example mapping of systematic bits to modulation constellation points.

FIG. 14 depicts example processing for MIMO communications with shaping, in accordance with certain aspects of the present disclosure.

FIG. 15 depicts example performance gains for MIMO communications with shaping, in accordance with certain aspects of the present disclosure.

FIG. 16 depicts a method for wireless communications.

FIG. 17 depicts a method for wireless communications.

FIG. 18 depicts aspects of an example communications device.

### DETAILED DESCRIPTION

Aspects of the present disclosure provide apparatuses, methods, processing systems, and computer-readable mediums for multiple-input multiple-output (MIMO) communications with probabilistic shaping.

MIMO refers to a technique in wireless communications that uses multiple antennas at both the transmitter and receiver to improve communication performance. MIMO may help enhance data throughput and link reliability without needing additional bandwidth or increased transmission power. Data throughput may be increased by sending multiple independent data streams simultaneously, by using different antennas to carry different signals over the same frequency band. Reliability may be improved by transmitting the same signal through multiple paths, which may help combat fading (signal weakening due to obstacles or interference).

In case of MIMO transmission with more than one layer, diagonal mapping of code blocks to the transmission resource (time/frequency) grid with successive interference cancellation may allow substantially improve the channel coding performance due to demodulation/demapping gains. One consequence of diagonal mapping is that different layers may be imbalanced in terms of interference, due to one layer interfering with the other.

Aspects of the present disclosure may help address this imbalance by using probabilistic shaping with MIMO. Probabilistic shaping aims to improve spectral efficiency for analog white Gaussian noise (AWGN) channels, but may put limitations on the coding rate as high modulation order may also require high coding rate, which can be problematic for fading channels. According to certain aspects, using spatially coupled MIMO layers may be grouped together into layer blocks and each block may be shaped independently. This approach may help allow independent processing of each block may also allow for the use of lower coding rates.

Certain aspects of the present disclosure also propose the use of different modulation orders for different blocks to account for the imbalance caused by the diagonal mapping.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

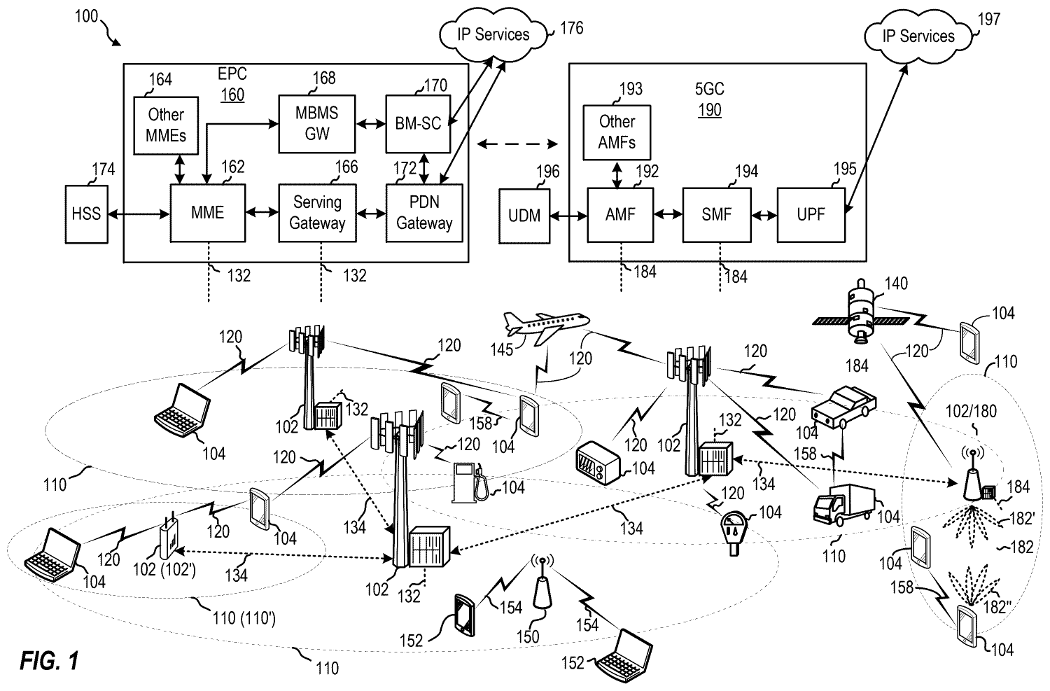

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (CNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

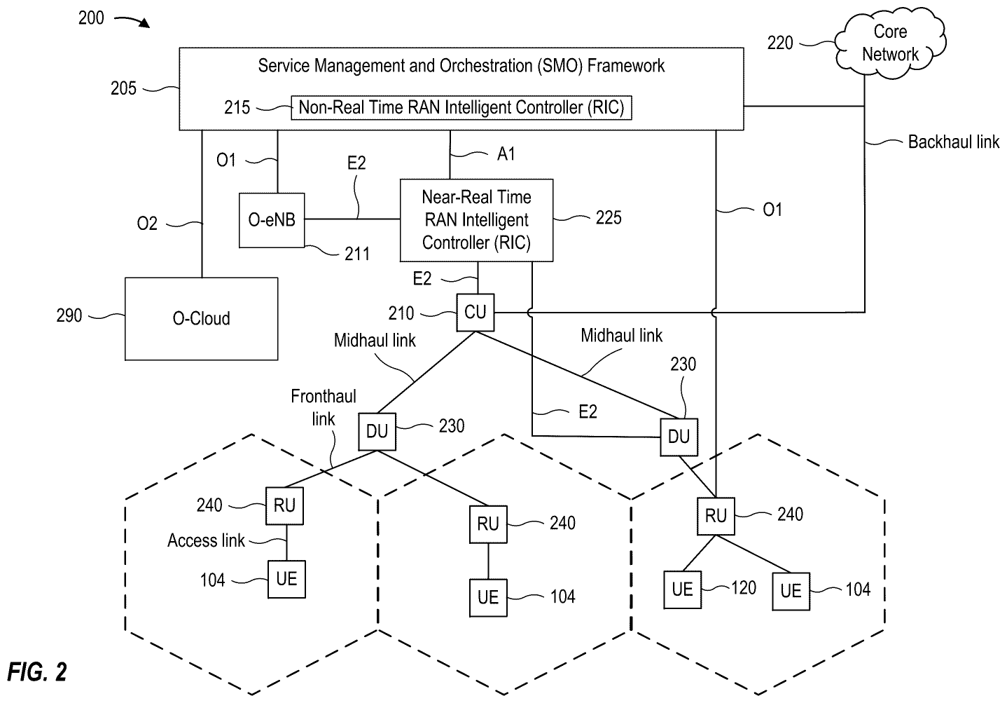

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mm Wave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

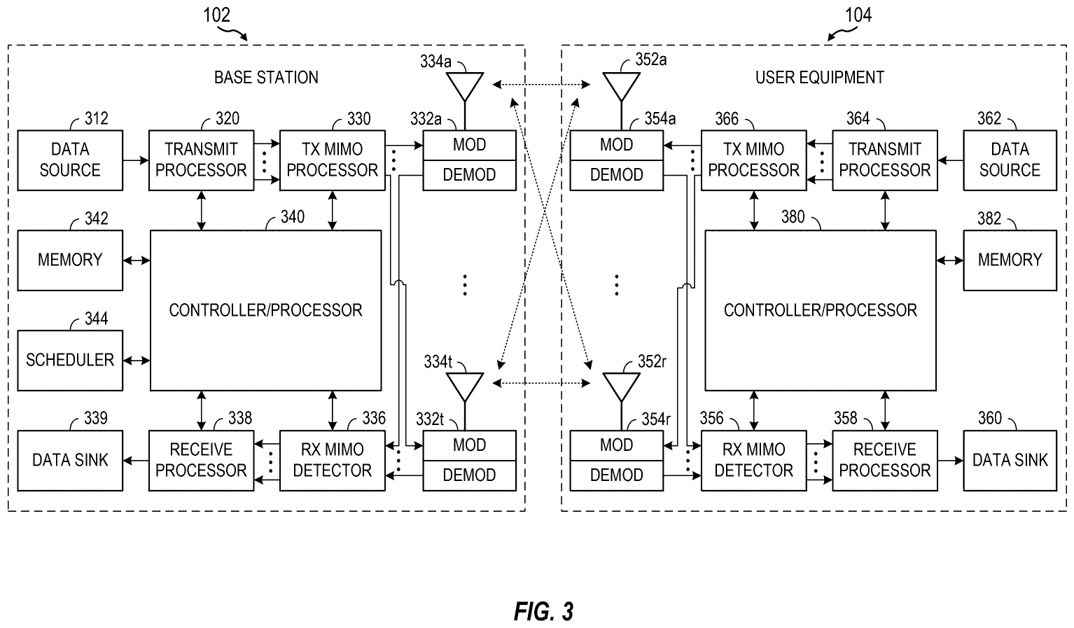

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

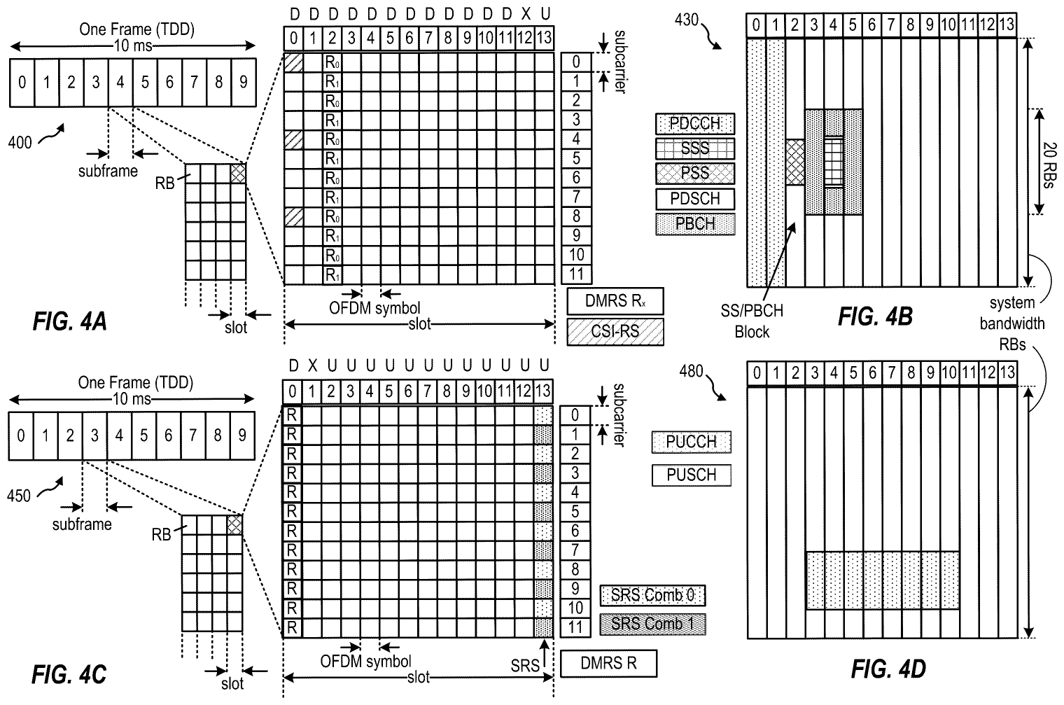

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Probabilistic Shaping

Communication over a channel is possible if the transmission rate over the channel satisfies a capacity based on the transmission power and the signal-to-noise ratio (SNR). The Shannon Capacity refers to a theorem that defines a maximum amount of information that can be transmitted over a channel (e.g. a wireless channel). Traditionally used coded modulation (CM) techniques, such as amplitude shift keying (ASK) and quadrature amplitude modulation (QAM), have signal constellations that are characterized by equidistant signal points and uniform signaling (e.g., a non-Gaussian distribution of information), meaning each signal point is transmitted with a same probability. Unfortunately, uniform signaling may optimistically achieve an achievable information rate (AIR) that is 1.53 dB (0.255 bits per dimension (bit/1-D)) away from the capacity of the AWGN channel (sometimes referred to as the “shaping gap”).

To close the shaping gap and to increase spectral efficiency, signal shaping techniques may be applied to generate a non-uniform distribution of the information. For example, in geometric shaping, constellation points are arranged in the complex plane in a non-equidistant manner to mimic a capacity achieving distribution. Probabilistic shaping, on the other hand, starts with a constellation with equidistant signal points (e.g., ASK or QAM) but assigns different probabilities to different constellation points.

In existing wireless communication standards (e.g., cellular and WiFi), higher-order modulation (e.g., 16-QAM, 64-QAM, or 256-QAM) are used to increase the spectral efficiency at higher SNR values.

In a typical QAM-based transmission processing flow, an information payload (e.g., K information bits) may be encoded, with channel coding to generate a set of coded bits. The actual bit stream after channel encoding may not be uniformly distributed. As such, a scrambling technique may be used to scramble the coded bits after the encoder with some uniform random bits. Uniform distributed bits implies that the modulation symbols after modulation are uniformly distributed over the constellation set.

In conventional systems, the constellations are fixed (typically square constellations as with the 16-QAM constellation), and each constellation point is used with equal probability. Probabilistic shaping generates non-uniformly distributed coded modulation symbols and is typically used to improve the spectral efficiency of the coded modulation. The main goal of probabilistic shaping is typically to generate non-uniformly distributed constellations. This can achieve larger mutual information than conventional uniformly distributed constellations at the same SNR. Examples of probabilistic shaping include probabilistic amplitude shaping (PAS), which shapes the amplitude of the constellation, but leaves the sign of the constellation uniformly distributed. Probabilistic shaping is also known as distribution matching (DM).

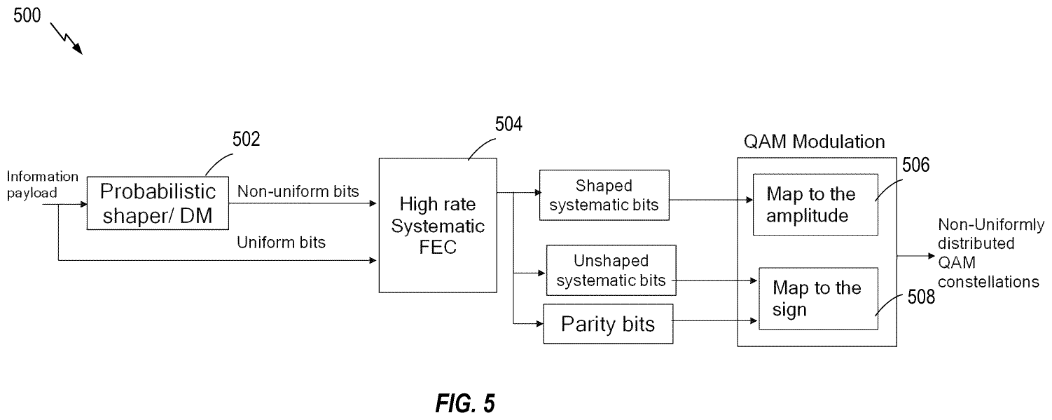

In an example transmitter processing flow illustrated in FIG. 5, a probabilistic shaper (block 502) precedes forward error correction (FEC) coding (block 504). A portion of information payload (I/P) bits is received by the probabilistic shaper, which generates non-uniform bits. A portion of the I/P bits may bypass the probabilistic shaper as uniform bits. The FEC encoder may take the non-uniform bits and uniform bits and generate shaped systematic bits, unshaped systematic bits, and parity bits. These bits are mapped to quadrature amplitude modulation (QAM) symbols by an amplitude mapping component 506 and sign mapping component 508. Resulting QAM symbols are then transmitted over the wireless medium to a wireless receiver.

At the wireless receiver, complementary processing may be performed (in reverse order). The wireless receiver may receive the shaped symbols from the transmitter and perform physical layer processing to recover a sequence of bits corresponding to the original information payload (I/P).

As described above, probabilistic shaping may involve the generation of non-uniformly distributed constellations, which can achieve a larger mutual information I(X;Y) than uniformly distributed constellations at the same SNR. For example, given k information bits, n₁>k bits b₁, . . . , bₙ_{₁} may first be generated through shaping/distribution matching, such that, Hp (b₁, . . . , bₙ_{₁})=k. The n₁ shaped bits may then be encoded with a channel code (e.g., low-density parity check-LDPC) to generate n coded bits. The overall rate of the scheme is thus Rₒᵥₑᵣₐₗₗ=R_{FEC}·R_{shaping}.

There are potential issues with probabilistic shaping. For example, only systematic bits can be shaped, which may place a lower bound on coding rate:

$${R}_{FEC} \geq \frac{m - 1}{m}$$

for 2^{m}-PAM modulation (or 2^{2m}-QAM). Very high coding rate may be a drawback in MIMO channels.

### Aspects Related to Spatially Coupled Multiple-Input Multiple-Output Communications

Certain aspects of the present disclosure are directed towards a structure of a spectrum for spatially coupled multiple-input multiple-output (MIMO) communications. A MIMO transmitter or receiver may be implemented with multiple layers. A layer may refer to a data stream, and each data stream may be transmitted and received via one of multiple antennas used to implement a MIMO transmitter or receiver. For MIMO, at least two layers may be used and the number of layers may be less than or equal to the number of antennas. In some cases, MIMO may be implemented using a single-code word (CW) or a dual-CW implementation. For example, a code block (CB) may include a single CW or two CWs. A CW may refer to data before the data is formatted for transmission. One or two code words (e.g., CW0 and CW1) can be used, where the number of CWs may depend on the channel conditions.

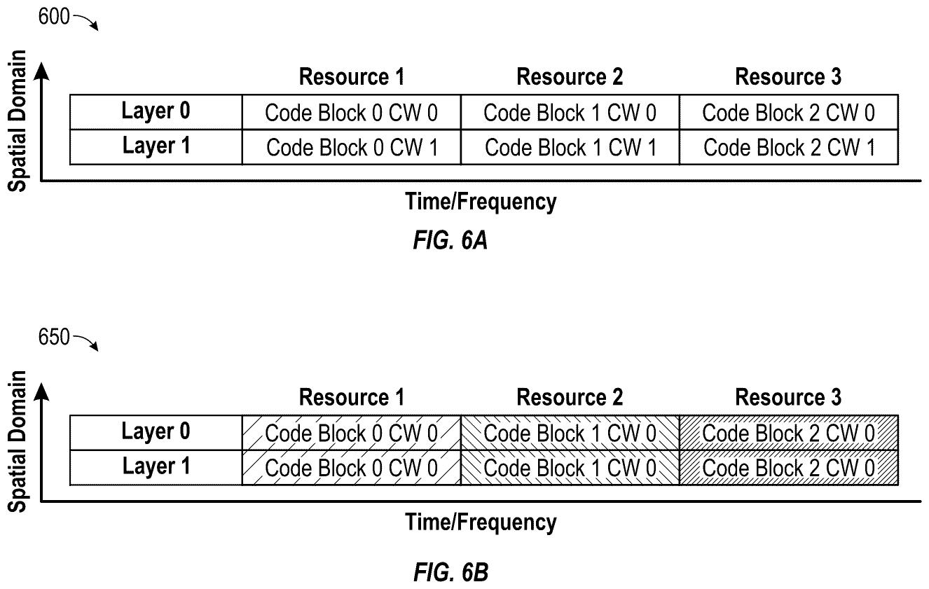

FIG. 6A illustrates a dual CW MIMO design structure 600. As shown, CW0 and CW1 for CB0 may be transmitted via layer 0 and layer 1 using first time and/or frequency resource (e.g., referred to as “Resource 1”), respectively, followed by CW0 and CW1 for CB1 transmitted via layer 0 and layer 1 using second time and/or frequency resource (e.g., referred to as a “Resource 2”) and so on. Each resource may represent any suitable time and frequency resource. For example, each resource may include less than or more than one OFDM symbol. The resources (e.g., Resource 1 and Resource 2) may represent the same number of resources. For example, each of the resources may be two OFDM symbols. CW0 and CW1 may be assigned different rates.

In some aspects, successive interference cancellation (SIC) may be applied to facilitate decoding of CBs. SIC is a technique that may be used by a receiver that allows the decoding of two or more CBs that have been received at least partly simultaneously. For example, a part of a first CB may interfere with a part of a second CB. Once the first CB is decoded, the first CB may be re-encoded and subtracted from a signal including the second CB to reduce interference for decoding the second CB. For example, a stronger CB (e.g., a CB transmitted with improved channel conditions, which may be referred to as a “head CB”) may be decoded first, re-encoded, and the re-encoded CB may be subtracted from the signal to reduce interference from the CB before decoding the other CB.

FIG. 6B illustrates a single CW design structure 650. In some cases, an irregular low-density parity check (LDPC) may be used. LDPC is a linear error correction code used to transmit a message over a noisy transmission channel. In some implementations, iterative demodulation and decoding across the two layers may be performed to increase decoding performance.

In some cases, a single CW design with spatial coupling, referred to as a diagonal BLAST type (or D-BLAST), may be used where BLAST stands for “Bell Laboratories Layered Space-Time.” In this case, a single CW rate is selected to match the collective channel quality across multiple layers.

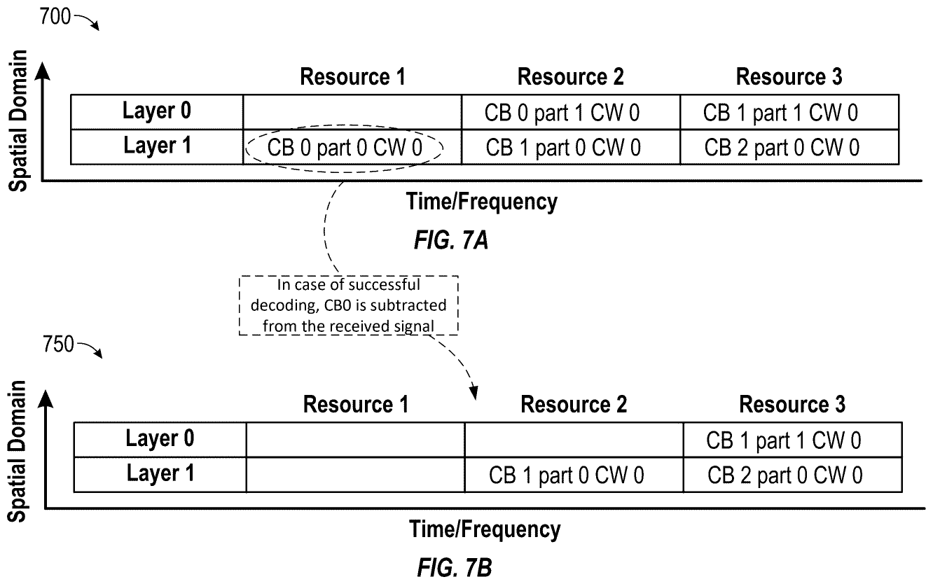

FIG. 7A illustrates an example code structure similar to D-BLAST with one codeword that may be designed to captures more channel realizations. As illustrated in FIG. 7B, successive interference cancellation (SIC) may be performed at the receiver side. In the illustrated example, CB0 is demodulated and decoded first. In case of successful decoding, CB0 is subtracted from the received signal, and then CB1 is demodulated and decoded. Similarly, in case of successful decoding, CB1 is subtracted from the received signal and CB 2 is demodulated and decoded. This procedure may be repeated until all CBs are successfully decoded or CB decoding failure is declared.

Aspects Related to Spatially Coupled MIMO Communications with Shaping

Aspects of the present disclosure provide apparatuses, methods, processing systems, and computer-readable mediums for multiple-input multiple-output (MIMO) communications with probabilistic shaping.

The techniques proposed herein may help allow independent processing of code blocks and may also allow for the use of lower coding rates. Certain aspects of the present disclosure also propose the use of different modulation orders for different blocks to account for the imbalance caused by the diagonal mapping.

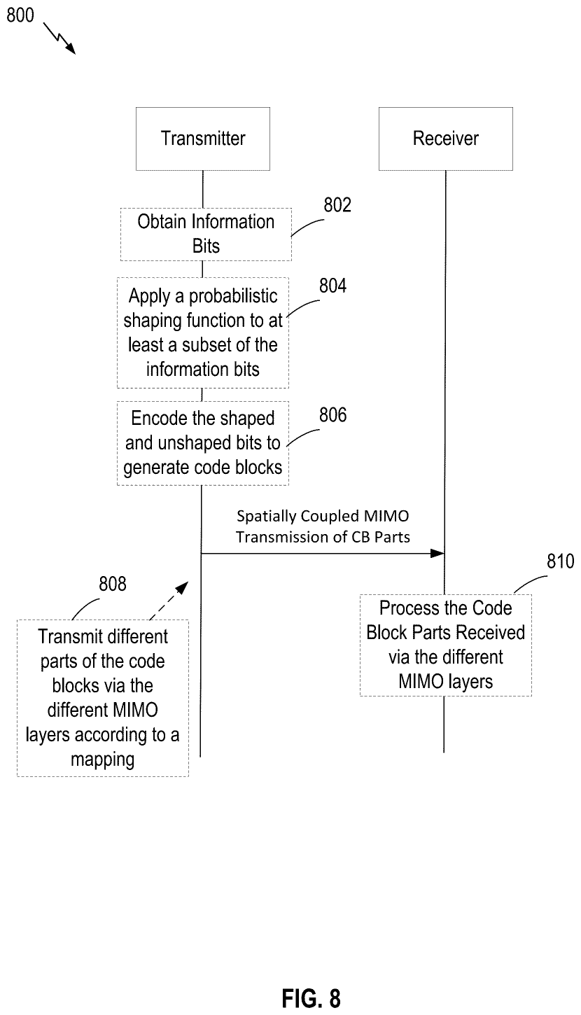

The techniques for spatially coupled MIMO with shaping may be understood with reference to the call flow diagram 800 of FIG. 8. In some aspects, the transmitter shown in FIG. 8 may be an example of the UE 104 or the BS 102 depicted and described with respect to FIGS. 1 and 3 or a disaggregated base station depicted and described with respect to FIG. 2. Similarly, the receiver shown in FIG. 8 may be an example of the BS 102 or the UE 104 depicted and described with respect to FIGS. 1 and 3 or a disaggregated base station depicted and described with respect to FIG. 2.

As illustrated at 802, the transmitter obtains information bits. As illustrated at 804, the transmitter may apply a probabilistic shaping function to at least a subset of the information bits. As illustrated at 806, the transmitter may encode the shaped and unshaped bits to generate code blocks.

As indicated at 808, the transmitter may then transmit different parts of the code blocks via the different MIMO layers according to a mapping.

At the receiver, complementary processing may be performed (in reverse order). For example, as indicated at 810, the receiver may process the CB parts received via the different MIMO layers (to recover a sequence of bits corresponding to the original information bits).

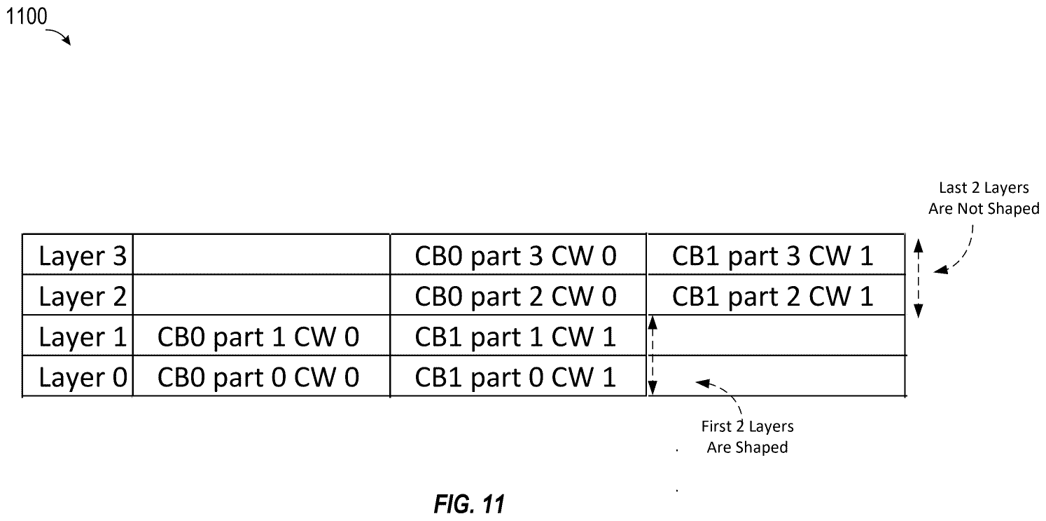

According to certain aspects, spatially-coupled MIMO with diagonal mapping and successive interference cancellation (SIC) may be utilized together with probabilistic shaping. In some cases, diagonal mapping may be performed on the layer level (as shown in FIGS. 6A and 6B). In case of more than two layers, layers may be partitioned (e.g., split) into layer blocks and the diagonal mapping may be performed on the block level (as will be described in greater detail with reference to FIG. 11). In some cases, different layers (or layer blocks) may use different modulation orders and different probabilistic shaping rates.

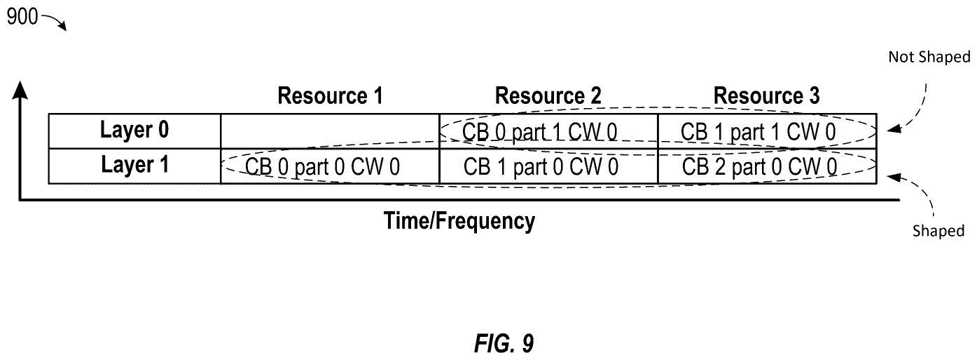

As described above, an SC-MIMO structure may result in a substantial imbalance between the blocks. Aspects of the present disclosure, however, may exploit this structure by choosing a different modulation order and shaping rate for blocks according to their reliability (e.g., level of interference). As illustrated in diagram 900 of FIG. 9, one option is to shape layers with full interference and use uniform QAM for low-interference layers. In some cases, a same modulation order and shaping rate may be used for all layers.

In some cases, layer-level/block-level PAS (e.g., use different modulation order/shaping rate for different layers or layer blocks, data bits allocations between layer blocks) proposed herein may be involved when diagonal mapping is not used. For example, layer-level/block-level PAS proposed herein may be applied when NR type layer mapping is performed (i.e., no diagonal mapping nor SIC).

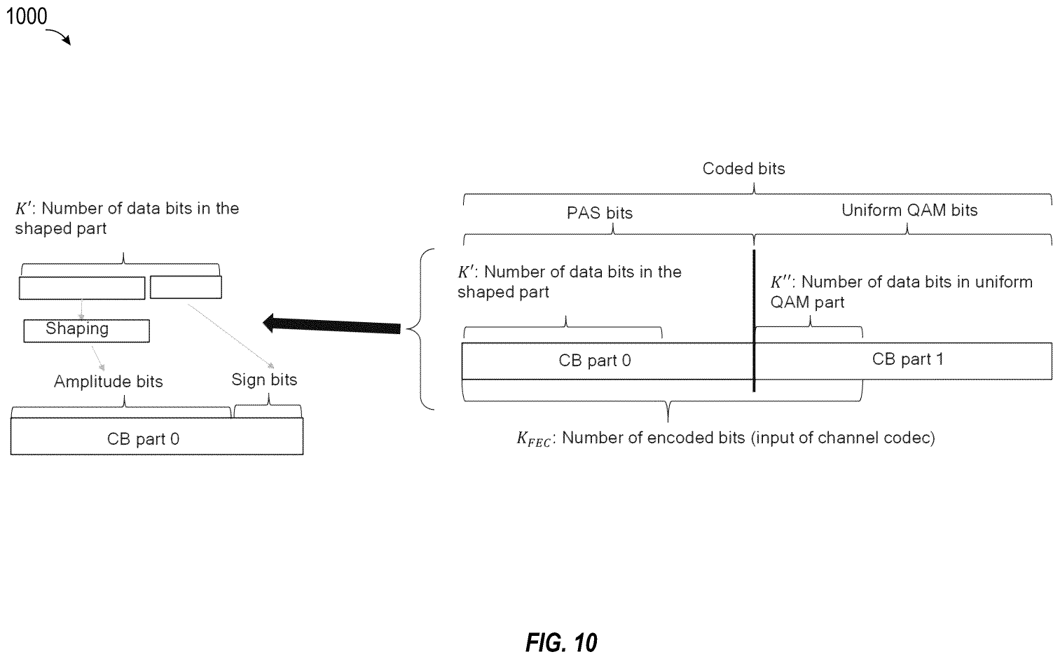

FIGS. 9 and 10 illustrate an example of spatially-coupled MIMO with layer-level probabilistic shaping for 2×2 MIMO, with two layers, where the coded bits include PAS bits and uniform QAM bits. The illustrated example assumes a same modulation order for all layers with m−1 amplitude levels. The example also assumes the first layer (layer 0) is shaped, that the second layer is not shaped, and that R_{FEC}>½.

The transmitter may need to set/fix R_{FEC} (which determine the number of encoded bits K_{FEC}) and Rₒᵥₑᵣₐₗₗ (which determines K′, +K″). As illustrated in diagram 1000 of FIG. 10, K′ is the number of data bits in the shaped part (CB part 0) and K″ is the number of (unshaped) data bits in the uniform QAM part (CP part 1). In other words, the actual number of data bits is K′+K″=N·Rₒᵥₑᵣₐₗₗ.

$$\frac{1}{m} \cdot \frac{N}{2}$$

Out of K′ data bits in the first half, may be mapped to the QAM symbol signs. The remaining

$${K}^{′} - \frac{1}{m} \cdot \frac{N}{2}$$

may be sent to the shaper to generate

$$\frac{m - 1}{m} \cdot \frac{N}{2}$$

non-uniform bits that are mapped to QAM symbol amplitudes. The K″ data bits in the second half may be left untouched. As a result, the first and second halves can be processed independently (demodulated, deinterleaved), where the resulting LLRs may be combined and sent to the decoder. The K′ shaped systematic bits mapped to amplitude, the unshaped bits mapped to sign bits.

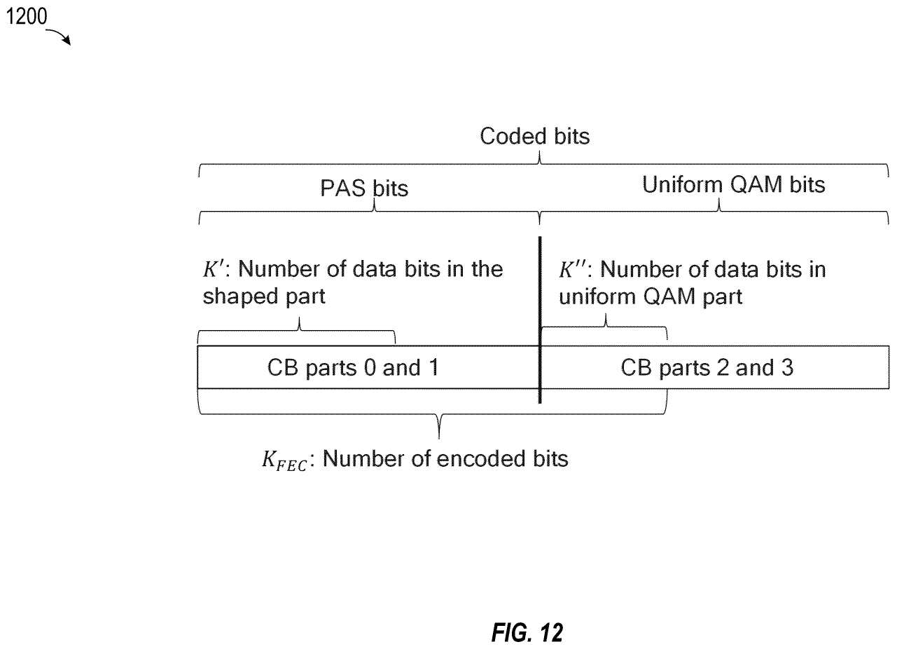

FIGS. 11 and 12 illustrate an example of spatially-coupled MIMO with block-level probabilistic shaping for 4×4 MIMO, with four layers. The example again assumes a same modulation order for all layers. The example also assumes the first block of layers (layer 0 and layer 1) is shaped, that the second layer is not shaped, and that R_{FEC}>½. In this manner, as shown in FIG. 12, processing of the two halves may be similar (or the same) to the 2×2 MIMO case described above.

What may be different, however, is the decomposition of the halves into sub-blocks corresponding to the layers. According to certain aspects, the non-uniform (shaped) bits and the uniform bits may be equally split between the layers. As an example, both layers 0 and 1 may have

$$\frac{m - 1}{m} \cdot \frac{N}{4}$$

non-uniform QAM amplitude bits and

$$\frac{1}{m} \cdot \frac{N}{4}$$

uniform QAM sign bits.

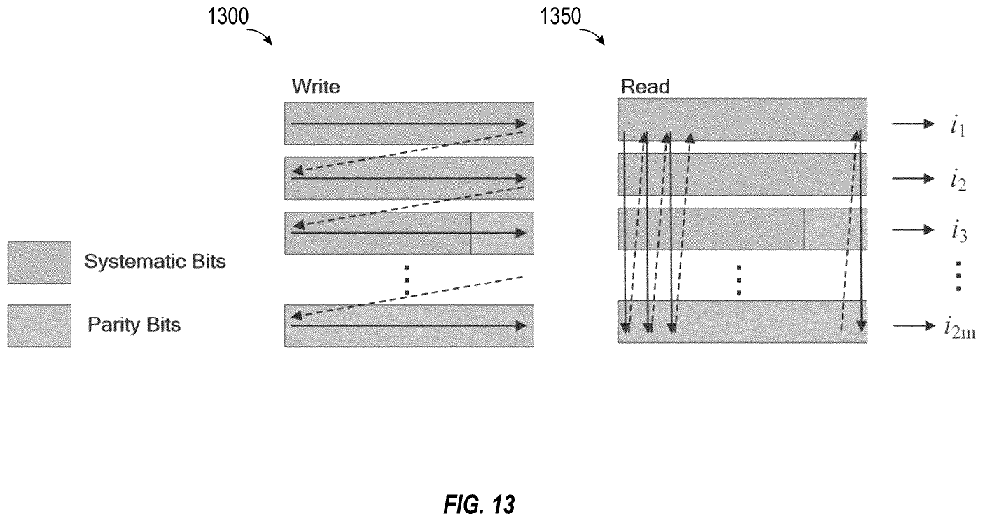

In some cases, the uniform QAM part may use a systematic bit prioritized mapping (SBPM) interleaver, as illustrated in FIG. 13. SBPM maps the systematic portion of the coded bits to the most significant bits (MSBs) of the modulation constellation and maps the non-systematic bits to the least significant bits (LSBs) of the modulation constellation.

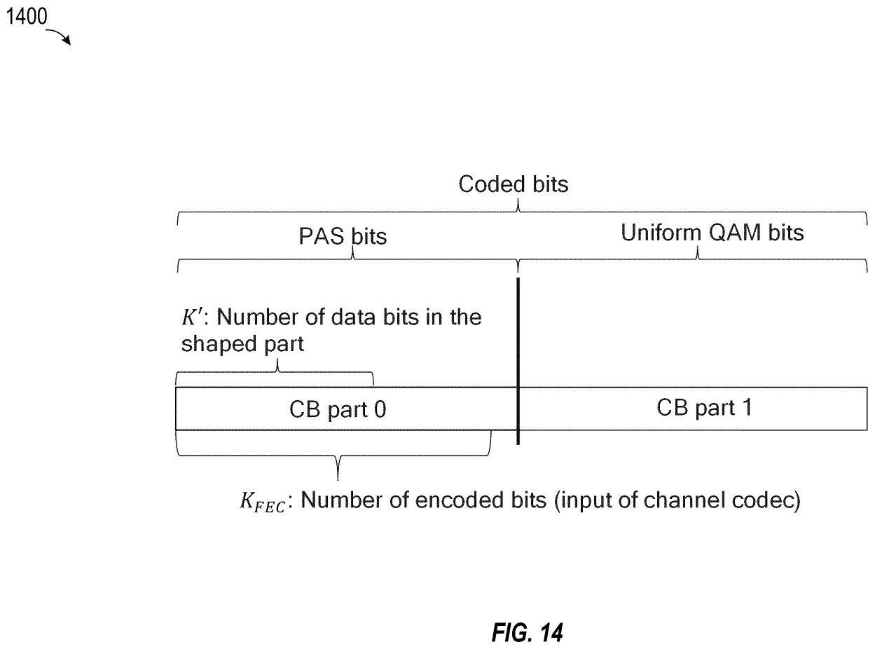

While certain illustrative examples described above assumed R_{FEC}>½, the techniques proposed herein may be used with R_{FEC}<½. In such cases, as illustrated in diagram 1400 of FIG. 14, all systematic bits may be in the first half. In this case, there are no data bits in the uniform QAM part (e.g., K″=0 and K′=N·Rₒᵥₑᵣₐₗₗ). The lower bound may thus be:

$${R}_{FEC} \geq \frac{1}{2} \cdot \frac{m - 1}{m} ,$$

since only systematic bits can be shaped. This may be generalized if shaping more than two layers. For example, assuming there are l layers and s of them are shaped, and then the lower bound becomes:

$${R}_{FEC} \geq \frac{s}{l} \cdot \frac{m - 1}{m} .$$

In other words, in the previous example, where l=4 and s=2 s/l=½. Those skilled in the art will appreciate that a similar (but more complex) expression can be derived for the case when different layer blocks have different modulation orders.

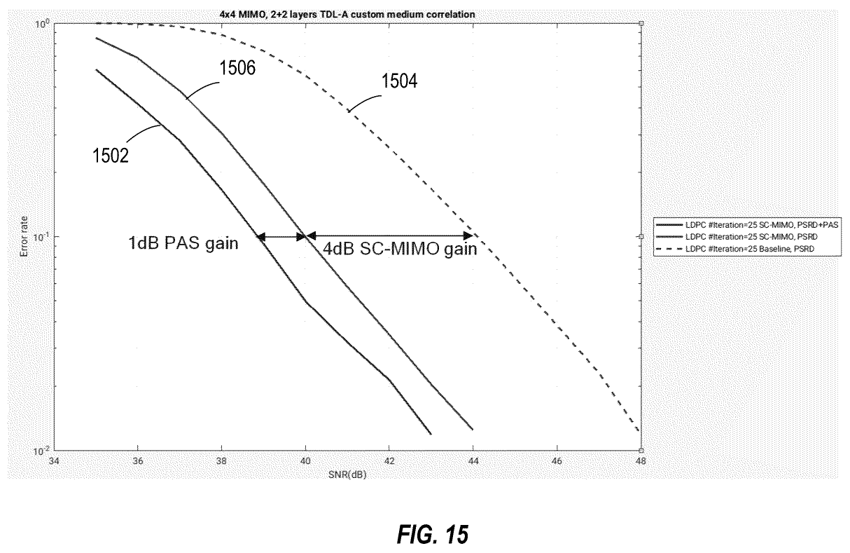

FIG. 15 illustrates an example of error rate versus signal to noise ratio (SNR) for different schemes. In the illustrated example, spatially-coupled MIMO with PAS on the second layer block (plot 1502) may achieve up to 5 dB gain for a 4×4 MIMO, 4 layer case, when compared to the baseline (plot 1504) with no shaping, no spatial coupling and no interference cancellation, and up to 1 dB gain when compared to (plot 1506) with spatial coupling and interference cancellation, but with no shaping.

### Example Operations

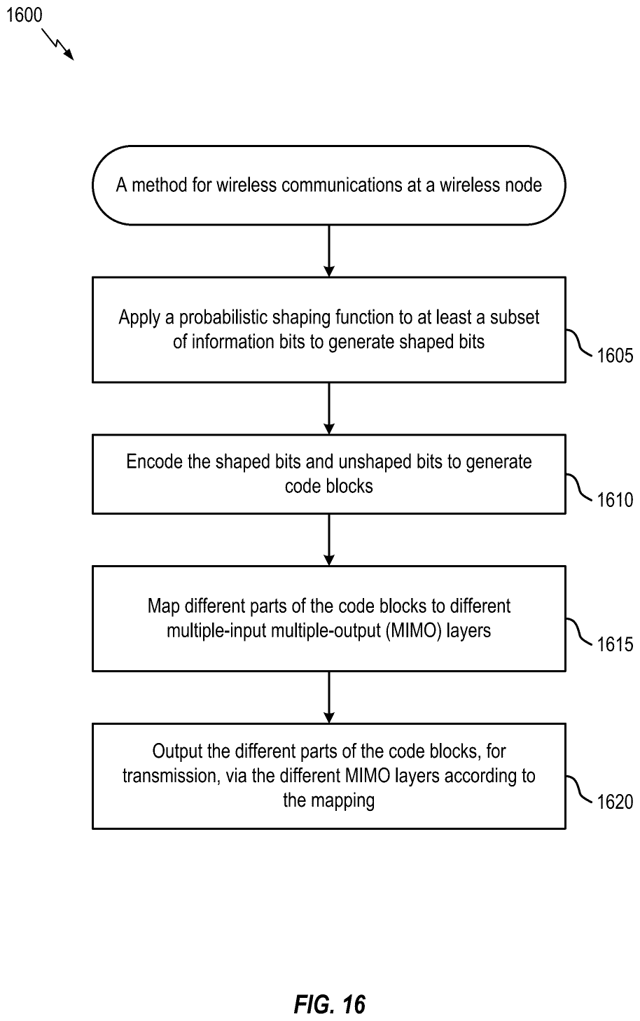

FIG. 16 shows an example of a method 1600 of wireless communications at a wireless node. In some examples, the wireless node is a user equipment, such as a UE 104 of FIGS. 1 and 3. In some examples, the wireless node is a network entity, such as a BS 102 of FIGS. 1 and 3, or a disaggregated base station as discussed with respect to FIG. 2.

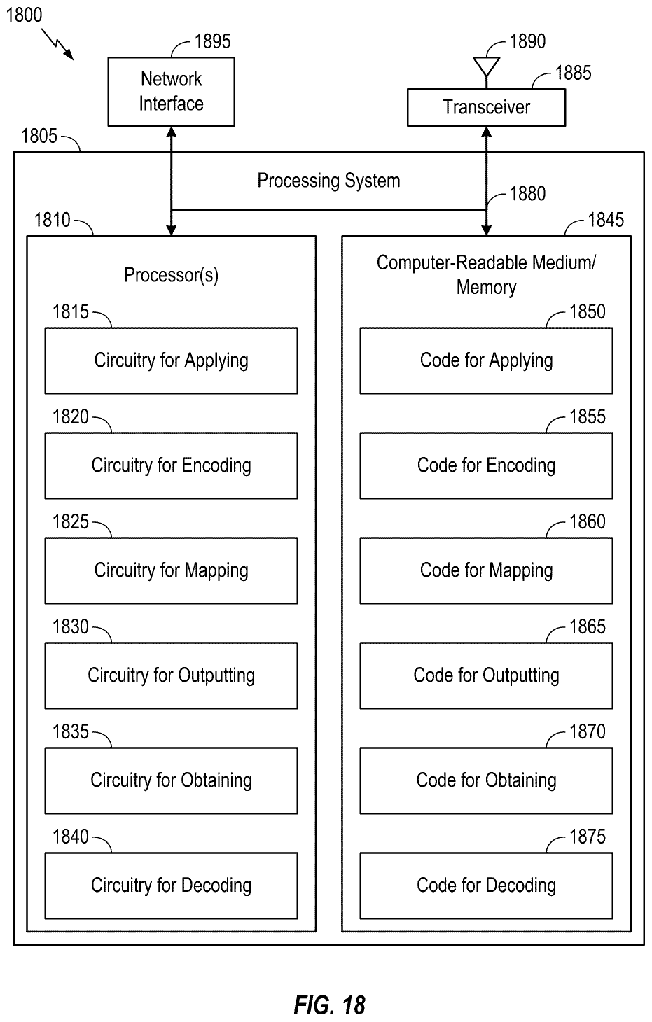

Method 1600 begins at step 1605 with applying a probabilistic shaping function to at least a subset of information bits to generate shaped bits. In some cases, the operations of this step refer to, or may be performed by, circuitry for applying and/or code for applying as described with reference to FIG. 18.

Method 1600 then proceeds to step 1610 with encoding the shaped bits and unshaped bits to generate code blocks. In some cases, the operations of this step refer to, or may be performed by, circuitry for encoding and/or code for encoding as described with reference to FIG. 18.

Method 1600 then proceeds to step 1615 with mapping different parts of the code blocks to different multiple-input multiple-output (MIMO) layers. In some cases, the operations of this step refer to, or may be performed by, circuitry for mapping and/or code for mapping as described with reference to FIG. 18.

Method 1600 then proceeds to step 1620 with outputting the different parts of the code blocks, for transmission, via the different MIMO layers according to the mapping. In some cases, the operations of this step refer to, or may be performed by, circuitry for outputting and/or code for outputting as described with reference to FIG. 18.

In some aspects, the mapping results in different MIMO layers having different levels of interference; and the method further comprises selecting at least one shaping rate, based on an level of interference associated with a MIMO layer to which corresponding parts of code blocks are mapped.

In some aspects, the selecting comprises: selecting a first shaping rate for the probabilistic shaping function applied to generate first shaped bits that are encoded to generate code block parts mapped to a first MIMO layer associated with a first level of interference; and selecting a second shaping rate for the probabilistic shaping function applied to generate second shaped bits that are encoded to generate code block parts mapped to a second MIMO layer associated with a second level of interference.

In some aspects, the selecting comprises selecting a first shaping rate for the probabilistic shaping function applied to generate shaped bits that are encoded to generate code blocks mapped to a first MIMO layer associated with a first level of interference; and the mapping comprises mapping code blocks generated by encoding unshaped bits to a second MIMO layer associated with a second level of interference lower than the first level of interference.

In some aspects, the mapping results in different MIMO layers having different levels of interference; and the method further comprises selecting at least one modulation order, based on an level of interference associated with a MIMO layer to which corresponding parts of code blocks are mapped.

In some aspects, the selecting: selecting a first modulation order to generate code blocks mapped to a first MIMO layer associated with a first level of interference; and selecting a second modulation order to generate code blocks mapped to a second MIMO layer associated with a second level of interference.

In some aspects, the selecting: selecting a first modulation order to generate code blocks mapped to a first MIMO layer associated with a first level of interference; and selecting the same first modulation order to generate code blocks mapped to a second MIMO layer associated with a second level of interference.

In some aspects, the mapping comprises: mapping a first part of a first code block to a first MIMO layer or first block of MIMO layers; mapping a second part of the first code block to a second MIMO layer or second block of MIMO layers; mapping a first part of a second code block to the first MIMO layer or first block of MIMO layers; and mapping a second part of the second code block to the second MIMO layer or second block of MIMO layers.

In some aspects, the outputting comprises: outputting, in a first time period, the first part of the first code block via the first MIMO layer or first block of MIMO layers; outputting, in a second time period, the second part of the first code block via the second MIMO layer or second block of MIMO layers and the first part of the second code block via the first MIMO layer or first block of MIMO layers; and outputting, in a third time period, the second part of the second code block via the second MIMO layer or second block of MIMO layers.

In some aspects, encoded shaped bits are mapped to the first MIMO layer or first block of MIMO layers and encoded unshaped bits are mapped to the second MIMO layer or second block of MIMO layers.

In some aspects, encoded shaped bits are mapped to the second MIMO layer or second block of MIMO layers and encoded unshaped bits are mapped to the first MIMO layer or first block of MIMO layers.

In some aspects, the encoding comprises using different modulation orders; and the mapping comprises mapping parts of code blocks encoded using the different modulation orders to different MIMO layers or different blocks of MIMO layers.

In one aspect, method 1600, or any aspect related to it, may be performed by an apparatus, such as communications device 1800 of FIG. 18, which includes various components operable, configured, or adapted to perform the method 1600.

Communications device 1800 is described below in further detail.

Note that FIG. 16 is just one example of a method, and other methods including fewer, additional, or alternative steps are possible consistent with this disclosure.

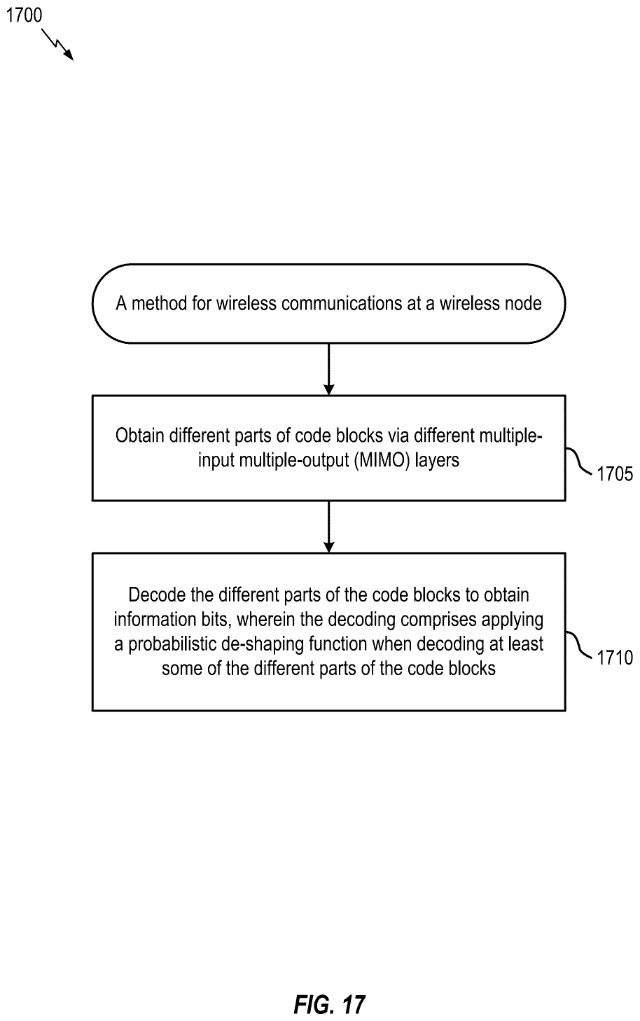

FIG. 17 shows an example of a method 1700 of wireless communications at a wireless node. In some examples, the wireless node is a user equipment, such as a UE 104 of FIGS. 1 and 3. In some examples, the wireless node is a network entity, such as a BS 102 of FIGS. 1 and 3, or a disaggregated base station as discussed with respect to FIG. 2.

Method 1700 begins at step 1705 with obtaining different parts of code blocks via different multiple-input multiple-output (MIMO) layers. In some cases, the operations of this step refer to, or may be performed by, circuitry for obtaining and/or code for obtaining as described with reference to FIG. 18.

Method 1700 then proceeds to step 1710 with decoding the different parts of the code blocks to obtain information bits, wherein the decoding comprises applying a probabilistic de-shaping function when decoding at least some of the different parts of the code blocks. In some cases, the operations of this step refer to, or may be performed by, circuitry for decoding and/or code for decoding as described with reference to FIG. 18.

In some aspects, the decoding comprises successive interference cancelation (SIC) that involves subtracting a successfully decoded first code block part from an obtained signal prior to decoding a second code block part.

In some aspects, applying the probabilistic de-shaping function is applied when decoding different parts of code blocks with shaped bits associated with at least first and second shaping rates.

In some aspects, the first shaping rate is associated with first parts of code blocks obtained via a first MIMO layer associated with a first level of interference; and the second shaping rate is associated with second parts of code blocks obtained via a second MIMO layer associated with a first level of interference.

In some aspects, the probabilistic de-shaping function is applied only when decoding parts of code blocks obtained via certain MIMO layers.

In some aspects, decoding first code block parts obtained via a first MIMO layer is based on a first modulation order; and decoding second code block parts obtained via a second MIMO layer is based on a second modulation order.

In some aspects, decoding first code block parts obtained via a first MIMO layer is based on a first modulation order; and decoding second code block parts obtained via a second MIMO layer is also based on the first modulation order.

In one aspect, method 1700, or any aspect related to it, may be performed by an apparatus, such as communications device 1800 of FIG. 18, which includes various components operable, configured, or adapted to perform the method 1700. Communications device 1800 is described below in further detail.

Note that FIG. 17 is just one example of a method, and other methods including fewer, additional, or alternative steps are possible consistent with this disclosure.

### Example Communications Device(s)

FIG. 18 depicts aspects of an example communications device 1800. In some aspects, communications device 1800 is a user equipment, such as UE 104 described above with respect to FIGS. 1 and 3. In some aspects, communications device 1800 is a network entity, such as BS 102 of FIGS. 1 and 3, or a disaggregated base station as discussed with respect to FIG. 2.

The communications device 1800 includes a processing system 1805 coupled to the transceiver 1885 (e.g., a transmitter and/or a receiver). In some aspects (e.g., when communications device 1800 is a network entity), processing system 1805 may be coupled to a network interface 1895 that is configured to obtain and send signals for the communications device 1800 via communication link(s), such as a backhaul link, midhaul link, and/or fronthaul link as described herein, such as with respect to FIG. 2. The transceiver 1885 is configured to transmit and receive signals for the communications device 1800 via the antenna 1890, such as the various signals as described herein. The processing system 1805 may be configured to perform processing functions for the communications device 1800, including processing signals received and/or to be transmitted by the communications device 1800.

The processing system 1805 includes one or more processors 1810. In various aspects, the one or more processors 1810 may be representative of one or more of receive processor 358, transmit processor 364, TX MIMO processor 366, and/or controller/processor 380, as described with respect to FIG. 3. In various aspects, one or more processors 1810 may be representative of one or more of receive processor 338, transmit processor 320, TX MIMO processor 330, and/or controller/processor 340, as described with respect to FIG. 3. The one or more processors 1810 are coupled to a computer-readable medium/memory 1845 via a bus 1880. In certain aspects, the computer-readable medium/memory 1845 is configured to store instructions (e.g., computer-executable code) that when executed by the one or more processors 1810, cause the one or more processors 1810 to perform the method 1600 described with respect to FIG. 16, or any aspect related to it; and the method 1700 described with respect to FIG. 17, or any aspect related to it. Note that reference to a processor performing a function of communications device 1800 may include one or more processors 1810 performing that function of communications device 1800.

In the depicted example, computer-readable medium/memory 1845 stores code (e.g., executable instructions), such as code for applying 1850, code for encoding 1855, code for mapping 1860, code for outputting 1865, code for obtaining 1870, and code for decoding 1875. Processing of the code for applying 1850, code for encoding 1855, code for mapping 1860, code for outputting 1865, code for obtaining 1870, and code for decoding 1875 may cause the communications device 1800 to perform the method 1600 described with respect to FIG. 16, or any aspect related to it; and the method 1700 described with respect to FIG. 17, or any aspect related to it.

The one or more processors 1810 include circuitry configured to implement (e.g., execute) the code stored in the computer-readable medium/memory 1845, including circuitry for applying 1815, circuitry for encoding 1820, circuitry for mapping 1825, circuitry for outputting 1830, circuitry for obtaining 1835, and circuitry for decoding 1840. Processing with circuitry for applying 1815, circuitry for encoding 1820, circuitry for mapping 1825, circuitry for outputting 1830, circuitry for obtaining 1835, and circuitry for decoding 1840 may cause the communications device 1800 to perform the method 1600 described with respect to FIG. 16, or any aspect related to it; and the method 1700 described with respect to FIG. 17, or any aspect related to it.

Various components of the communications device 1800 may provide means for performing the method 1600 described with respect to FIG. 16, or any aspect related to it; and the method 1700 described with respect to FIG. 17, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1885 and the antenna 1890 of the communications device 1800 in FIG. 18. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1885 and the antenna 1890 of the communications device 1800 in FIG. 18.

### Example Clauses

Implementation examples are described in the following numbered clauses:

Clause 1: A method for wireless communications at a wireless node, comprising: applying a probabilistic shaping function to at least a subset of information bits to generate shaped bits; encoding the shaped bits and unshaped bits to generate code blocks; mapping different parts of the code blocks to different multiple-input multiple-output (MIMO) layers; and outputting the different parts of the code blocks, for transmission, via the different MIMO layers according to the mapping.

Clause 2: The method of Clause 1, wherein: the mapping results in different MIMO layers having different levels of interference; and the method further comprises selecting at least one shaping rate, based on an level of interference associated with a MIMO layer to which corresponding parts of code blocks are mapped.

Clause 3: The method of Clause 2, wherein the selection comprises: selecting a first shaping rate for the probabilistic shaping function applied to generate first shaped bits that are encoded to generate code block parts mapped to a first MIMO layer associated with a first level of interference; and selecting a second shaping rate for the probabilistic shaping function applied to generate second shaped bits that are encoded to generate code block parts mapped to a second MIMO layer associated with a second level of interference.

Clause 4: The method of Clause 2, wherein: the selection comprises selecting a first shaping rate for the probabilistic shaping function applied to generate shaped bits that are encoded to generate code blocks mapped to a first MIMO layer associated with a first level of interference; and the mapping comprises mapping code blocks generated by encoding unshaped bits to a second MIMO layer associated with a second level of interference lower than the first level of interference.

Clause 5: The method of any one of Clauses 1-4, wherein: the mapping results in different MIMO layers having different levels of interference; and the method further comprises selecting at least one modulation order, based on a level of interference associated with a MIMO layer to which corresponding parts of code blocks are mapped.

Clause 6: The method of Clause 5, wherein the selection of the at least one modulation order comprises: selecting a first modulation order to generate code blocks mapped to a first MIMO layer associated with a first level of interference; and selecting a second modulation order to generate code blocks mapped to a second MIMO layer associated with a second level of interference.

Clause 7: The method of Clause 5, wherein the selection of the at least one modulation order comprises: selecting a first modulation order to generate code blocks mapped to a first MIMO layer associated with a first level of interference; and selecting the same first modulation order to generate code blocks mapped to a second MIMO layer associated with a second level of interference.

Clause 8: The method of any one of Clauses 1-7, wherein the mapping comprises: mapping a first part of a first code block to a first MIMO layer or a first block of MIMO layers; mapping a second part of the first code block to a second MIMO layer or a second block of MIMO layers; mapping a first part of a second code block to the first MIMO layer or first block of MIMO layers; and mapping a second part of the second code block to the second MIMO layer or the second block of MIMO layers.

Clause 9: The method of Clause 8, wherein the outputting comprises: outputting, in a first time period, the first part of the first code block via the first MIMO layer or the first block of MIMO layers; outputting, in a second time period, the second part of the first code block via the second MIMO layer or the second block of MIMO layers and the first part of the second code block via the first MIMO layer or the first block of MIMO layers; and outputting, in a third time period, the second part of the second code block via the second MIMO layer or the second block of MIMO layers.

Clause 10: The method of Clause 8, wherein: encoded shaped bits are mapped to the first MIMO layer or first block of MIMO layers and encoded unshaped bits are mapped to the second MIMO layer or the second block of MIMO layers.

Clause 11: The method of Clause 8, wherein: encoded shaped bits are mapped to the second MIMO layer or second block of MIMO layers and encoded unshaped bits are mapped to the first MIMO layer or first block of MIMO layers.

Clause 12: The method of Clause 8, wherein: the encoding comprises using different modulation orders; and the mapping comprises mapping parts of code blocks encoded using the different modulation orders to different MIMO layers or different blocks of MIMO layers.

Clause 13: A method for wireless communications at a wireless node, comprising: obtaining different parts of code blocks via different multiple-input multiple-output (MIMO) layers; and decoding the different parts of the code blocks, wherein the decoding comprises applying a probabilistic de-shaping function when decoding at least some of the different parts of the code blocks.

Clause 14: The method of Clause 13, wherein the decoding involves successive interference cancelation (SIC).

Clause 15: The method of any one of Clauses 13-14, wherein applying the probabilistic de-shaping function is applied when decoding different parts of code blocks with shaped bits associated with at least a first shaping rate and a second shaping rate.

Clause 16: The method of Clause 15, wherein: the first shaping rate is associated with first parts of code blocks obtained via a first MIMO layer associated with a first level of interference; and the second shaping rate is associated with second parts of code blocks obtained via a second MIMO layer associated with a first level of interference.

Clause 17: The method of Clause 15, wherein the probabilistic de-shaping function is applied only when decoding parts of code blocks obtained via certain MIMO layers.

Clause 18: The method of any one of Clauses 13-17, wherein: decoding first code block parts obtained via a first MIMO layer is based on a first modulation order; and decoding second code block parts obtained via a second MIMO layer is based on at least one of a second modulation order or the first modulation order.

Clause 19: An apparatus, comprising: at least one memory comprising executable instructions; and at least one processor configured to execute the executable instructions and cause the apparatus to perform a method in accordance with any combination of Clauses 1-18.

Clause 20: An apparatus, comprising means for performing a method in accordance with any combination of Clauses 1-18.

Clause 21: A non-transitory computer-readable medium comprising executable instructions that, when executed by at least one processor of an apparatus, cause the apparatus to perform a method in accordance with any combination of Clauses 1-18.

Clause 22: A computer program product embodied on a computer-readable storage medium comprising code for performing a method in accordance with any combination of Clauses 1-18.

Clause 23: A wireless node (e.g., a UE or network entity), comprising: at least one transceiver; at least one memory comprising instructions; and one or more processors, individually or collectively, configured to execute the instructions and cause the wireless node to perform a method in accordance with any one of clauses 1-12, wherein the at least one transceiver is configured to transmit the different parts of the code blocks via the different MIMO layers according to the mapping.

Clause 24: A wireless node (e.g., a UE or network entity), comprising: at least one transceiver; at least one memory comprising instructions; and one or more processors, individually or collectively, configured to execute the instructions and cause the wireless node to perform a method in accordance with any one of clauses 13-18, wherein the at least one transceiver is configured to receive the different parts of code blocks via the MIMO layers.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

Means for applying, means for encoding, means for mapping, means for outputting, means for selecting, means for using, means for obtaining, means for decoding, means for subtracting may comprise one or more processors, such as one or more of the processors described above with reference to FIG. 18.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, comprising:
at least one memory comprising computer-executable instructions; and
one or more processors configured to execute the computer-executable instructions and cause the apparatus to:
apply a probabilistic shaping function to at least a subset of information bits to generate shaped bits;
encode the shaped bits and unshaped bits to generate code blocks;
map different parts of the code blocks to different multiple-input multiple-output (MIMO) layers; and
output the different parts of the code blocks, for transmission, via the different MIMO layers according to the mapping.

2. The apparatus of claim 1, wherein:
the mapping results in different MIMO layers having different levels of interference; and
the one or more processors are further configured to cause the apparatus to select at least one shaping rate, based on a level of interference associated with a MIMO layer to which corresponding parts of code blocks are mapped.

3. The apparatus of claim 2, wherein the selection comprises:
selecting a first shaping rate for the probabilistic shaping function applied to generate first shaped bits that are encoded to generate code block parts mapped to a first MIMO layer associated with a first level of interference; and
selecting a second shaping rate for the probabilistic shaping function applied to generate second shaped bits that are encoded to generate code block parts mapped to a second MIMO layer associated with a second level of interference.

4. The apparatus of claim 2, wherein:
the selection comprises selecting a first shaping rate for the probabilistic shaping function applied to generate shaped bits that are encoded to generate code blocks mapped to a first MIMO layer associated with a first level of interference; and
the mapping comprises mapping code blocks generated by encoding unshaped bits to a second MIMO layer associated with a second level of interference lower than the first level of interference.

5. The apparatus of claim 1, wherein:
the mapping results in different MIMO layers having different levels of interference; and
the one or more processors are further configured to cause the apparatus to select at least one modulation order, based on a level of interference associated with a MIMO layer to which corresponding parts of code blocks are mapped.

6. The apparatus of claim 5, wherein the selection of the at least one modulation order comprises:
selecting a first modulation order to generate code blocks mapped to a first MIMO layer associated with a first level of interference; and
selecting a second modulation order to generate code blocks mapped to a second MIMO layer associated with a second level of interference.

7. The apparatus of claim 5, wherein the selection of the at least one modulation order comprises:
selecting a first modulation order to generate code blocks mapped to a first MIMO layer associated with a first level of interference; and
selecting the same first modulation order to generate code blocks mapped to a second MIMO layer associated with a second level of interference.

8. The apparatus of claim 1, wherein the mapping comprises:
mapping a first part of a first code block to a first MIMO layer or a first block of MIMO layers;
mapping a second part of the first code block to a second MIMO layer or a second block of MIMO layers;
mapping a first part of a second code block to the first MIMO layer or the first block of MIMO layers; and
mapping a second part of the second code block to the second MIMO layer or the second block of MIMO layers.

9. The apparatus of claim 8, wherein the outputting comprises:
outputting, in a first time period, the first part of the first code block via the first MIMO layer or the first block of MIMO layers;
outputting, in a second time period, the second part of the first code block via the second MIMO layer or the second block of MIMO layers and the first part of the second code block via the first MIMO layer or the first block of MIMO layers; and
outputting, in a third time period, the second part of the second code block via the second MIMO layer or the second block of MIMO layers.

10. The apparatus of claim 8, wherein encoded shaped bits are mapped to the first MIMO layer or first block of MIMO layers and encoded unshaped bits are mapped to the second MIMO layer or the second block of MIMO layers.

11. The apparatus of claim 8, wherein encoded shaped bits are mapped to the second MIMO layer or the second block of MIMO layers and encoded unshaped bits are mapped to the first MIMO layer or the first block of MIMO layers.

12. The apparatus of claim 8, wherein:
the encoding comprises using different modulation orders; and
the mapping comprises mapping parts of code blocks encoded using the different modulation orders to different MIMO layers or different blocks of MIMO layers.

13. The apparatus of claim 1, further comprising at least one transceiver configured to transmit the different parts of the code blocks via the different MIMO layers according to the mapping, wherein the apparatus is configured as a wireless station.

14. An apparatus for wireless communication, comprising:
at least one memory comprising computer-executable instructions; and
one or more processors configured to execute the computer-executable instructions and cause the apparatus to:
obtain different parts of code blocks via different multiple-input multiple-output (MIMO) layers; and
decode the different parts of the code blocks, wherein the decoding comprises applying a probabilistic de-shaping function when decoding at least some of the different parts of the code blocks.

15. The apparatus of claim 14, wherein the decoding involves successive interference cancelation (SIC).

16. The apparatus of claim 14, wherein the probabilistic de-shaping function is applied when decoding different parts of code blocks with shaped bits associated with at least first shaping rate and second shaping rate.

17. The apparatus of claim 16, wherein:
the first shaping rate is associated with first parts of code blocks obtained via a first MIMO layer associated with a first level of interference; and
the second shaping rate is associated with second parts of code blocks obtained via a second MIMO layer associated with a second level of interference.

18. The apparatus of claim 14, wherein:
decoding first code block parts obtained via a first MIMO layer is based on a first modulation order; and
decoding second code block parts obtained via a second MIMO layer is based on at least one of a second modulation order or the first modulation order.

19. The apparatus of claim 1, further comprising at least one transceiver configured to receive the different parts of the code blocks via the different MIMO layers, wherein the apparatus is configured as a wireless station.

20. A method for wireless communications at a wireless node, comprising:
applying a probabilistic shaping function to at least a subset of information bits to generate shaped bits;
encoding the shaped bits and unshaped bits to generate code blocks;
mapping different parts of the code blocks to different multiple-input multiple-output (MIMO) layers; and
outputting the different parts of the code blocks, for transmission, via the different MIMO layers according to the mapping.
